(19) United States
(12) Patent Application Publication
(10) Pub. No.: US 2023/0054835 A1
(43) Pub. Date: Feb. 23, 2023

(54) System And Method For Tracking Flight Of Birds

(71) Applicant: Joseph Charles CURRY, Holly, MI (US)

(72) Inventor: Joseph Charles CURRY, Holly, MI (US)

(21) Appl. No.: 17/865,698

(22) Filed: Jul. 15, 2022

Related U.S. Application Data
(60) Provisional application No. 63/234,770, filed on Aug. 19, 2021.

(51) Int. Cl. G07F 17/32; A63K 3/00; A01K 15/02

(52) U.S. Cl. CPC G07F 17/3288; A63K 3/00; A01K 15/02

(57) ABSTRACT

A solo pigeon loft may be operated by a single user to provide a plurality of racing pigeons from the solo pigeon loft. The plurality of pigeons from the solo pigeon loft may be used in a pigeon race. The racing pigeons from the solo pigeon loft, therefore allow for a pigeon race without inclusion of racing pigeons from a separate distinct pigeon block.

### CROSS-REFERENCE TO RELATED APPLICATIONS

This application claims the benefit of U.S. Provisional Application No. 63/234,770, filed on Aug. 19, 2021, entitled “SYSTEM AND METHOD FOR TRACKING FLIGHT OF BIRDS”. The entire disclosure(s) of (each of) the above application(s) is (are) incorporated herein by reference.

### FIELD

The subject disclosure relates to bird flight tracking, in particularly to racing of a plurality of birds between at least two locations.

### BACKGROUND

This section provides background information related to the present disclosure which is not necessarily prior art.

Various sporting events include the racing of a plurality of pigeons. The plurality of pigeons may be from a plurality of pigeon lofts. Each pigeon loft is generally owned or operated by a separate individual or entity. Thus, the racing pigeons from each pigeon loft are related to the specific individual pigeon loft are controlled by that individual pigeon loft. Certain pigeon races may include those sanctioned by the American Racing Pigeon Union, Inc. and/or any known registration union.

The racing pigeons may be placed at a first location and race to a second location. Generally the racing pigeons have been trained or conditioned to travel to the second or final location for the race. The race occurs over the time of flight of the racing pigeons from the first or start location to the second or finish location.

In various races, a plurality of racing pigeons from a plurality of pigeon lofts that own or keep the pigeons are moved to a single starting location and then are released to race to the final location. The plurality of racing pigeons may be brought by a plurality of individual owners or pigeon loft owners to the starting location. Therefore, each of the pigeon loft owners must condition their racing pigeons separately to race to the single ending location.

In various other situations a plurality of pigeon loft owners may provide birds to a separate pigeon loft. The single pigeon loft may then condition all of the birds from a plurality of pigeon lofts to travel to a finished location for a race. However, each of the plurality of pigeons may owned by a plurality of different and distinct pigeon lofts.

### SUMMARY

This section provides a general summary of the disclosure, and is not a comprehensive disclosure of its full scope or all of its features.

A single or solo pigeon loft may be a location where an individual or entity owns two or more pigeons. The two or more pigeons may be raised and cared for at the solo pigeon loft. All of the pigeons may be owned by the solo pigeon loft owner. At the solo loft all of the pigeons may and/or are trained by a single individual or entity.

A race may occur when two or more of the pigeons from the solo pigeon loft are moved or positioned for a race on a race day. On the race day the plurality of pigeons may be released to race to a single location, such as the solo pigeon loft. The racing pigeons may be tracked and/or determined for order of finishing the race. While the race may be with racing pigeons only from a solo pigeon loft and owned by a single owner or entity, each of the pigeons may be individually identified for racing statistics. Racing statistics may include time of racing, order of finishing the race, or other statistics.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a pigeon race to a solo loft and related entities;

FIG. 2 is a flow chart of a solo pigeon loft pigeon race, race tracking, and bookmaking; and

FIG. 3 is a flowchart of a solo pigeon loft bookmaking method.

Corresponding reference numerals indicate corresponding parts throughout the several views of the drawings.

### DETAILED DESCRIPTION

Example embodiments will now be described more fully with reference to the accompanying drawings.

A number of pigeons, such as racing pigeons, can be provided or kept at a single or solo pigeon location or loft. The solo pigeon loft may include a plurality of pigeons that may be trained over a selected period of time to return to a selected location, such as a location of the solo pigeon loft. The pigeons from the solo pigeon loft, therefore, may be moved to a selected location a distance from the solo pigeon loft location and fly back to the solo pigeon loft or selected single location at a selected date or time. The solo pigeon loft therefore contains pigeons that may be only owned by a single entity or single pigeon loft owner. The single entity or single pigeon loft owner may be a trainer or keeper of the pigeons.

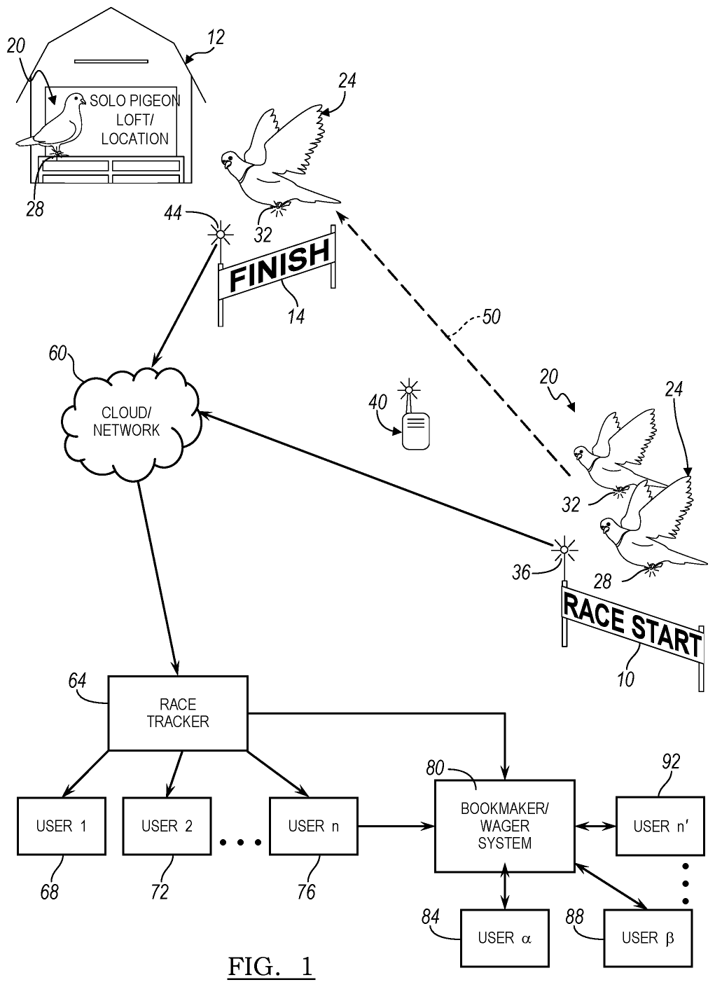

With reference to FIG. 1, for example, a plurality of racing pigeons from a solo pigeon loft 12 may initiate a race at a race start 10. The race start 10 may any appropriate race start, such as a location a selected distance from the solo pigeon loft/location 12 which may also be a finish location 14. The start location at the race start 10 may be a selected distance, such as 50 miles, 60 miles, 600 miles, or any appropriate distance from the finish location 14.

The plurality of racing pigeons may, for example, include a first pigeon 20 and a second pigeon 24. Each of the racing pigeons may have unique identifiers, such as a leg band or transceiver that may include a receiver and/or transmitter. For example, the first pigeon 20 may include a first unique identifier 28 that may be or include a transceiver or band. The second pigeon 24 may include a second unique identifier 32 that may include a band or transceiver.

Each of the unique identifiers 28, 32 may transmit and/or receive a signal from a start system 36. The start system 36 may be associated with the race start 10, such as at a specific location or area. The start system 36 may include a communication portion or link configured to identify the unique identifiers 28, 32. The identification may include a unique wireless signal (e.g., codes radio signal, wireless communication protocol, etc.)

Each of the respective unique identifiers 28, 32 may be activated or tracked at selected way points or tracking portions, such as a tracking portion 40. The tracking portion 40 may wirelessly receive tracking information regarding the selected location of the pigeons, such as the first pigeon 20 and/or the second pigeon 24. The tracking information collected with the tracking portion 40 may be transmitted, as discussed further herein, for tracking the race of the race pigeons 20, 24. For example, the tracking portion 40 may have a selected range (e.g., 1000 yards) and receives a signal from one of more of the unique identifiers 28, 32 when in the selected range. The tracking portion 40 may then transmit the time when the signal from the unique identifiers 28, 32 is received to allow determination of a time and location of any of the unique identifiers 28, 32.

A start may be initialized or begun when the pigeons 20, 24 leave a selected race start position, such as a race start 10. The selected pigeons, such as the first and second pigeons 20, 24 may fly to the finish 14. At the finish 14 a finish communication system 44 may receive a signal from the unique identifiers 28, 32 at a determined or known time which may be the finish time. The finish time may then be transmitted.

For example, the second pigeon 24 may pass the finish marker 14 and the unique identifier 32 may transmit a signal and/or receive a signal from the finish system 44 to mark a finish time, such as a precise date and time that the second pigeon 24 passes the finish marker 14. Other racing pigeons from the solo pigeon loft 12 may follow any appropriate path, such as a path 50 from the race start 10 to the finish 14. As noted above, each of the pigeons, such as the first and second pigeons 20, 24 may be from the solo pigeon loft/location 12 that may also be at or adjacent to the finish 14. Accordingly, each of the pigeons 20, 24 may be raised at a solo pigeon loft location and/or owned by a solo pigeon loft owner such that a single owner or location may provide all pigeons for a selected race, which may also be referred to as a solo pigeon loft race, that may race from the race start 10 to the finish 14.

The race start information may be transmitted from the race start system 36 to a selected network system, such as an internet or cloud network system 60. Similarly, information regarding the finish time may be transmitted from the finish system 44 to the clouded/network 60. The information may then be transmitted and/or received by a race tracker 64.

The race tracker 64 may receive and identify the specific pigeons, such as the first and second pigeons 20, 24 and the related start times and dates at the start 10 and the respective finish times at the finish 14. The race tracker 64, therefore, may include or accumulate all data regarding the race start and finish times for each of the respective pigeons and allow access by selected user such as a first user 68, a second user 72, and any appropriate number of users 76.

The users 68-76 may access the race tracker system 64 to request and/or receive information regarding the respective racing pigeons and the statistics thereto, such as the racing data regarding the race start 10 to the finish 14. Each of the users 68-76 may also communicate with the race tracker 64 throughout their selected purposes, such as wagering on a selected race, purchasing and/or requesting selected data regarding any respective individual birds and/or a plurality of birds from the solo pigeon loft/location 12, or other appropriate information. The race tracker 64, therefore, may be an information broker. The race tracker 64 may be controlled by the solo pigeon loft or independent therefrom.

In addition to and/or combined therewith, the race tracker system 64 may be a bookmaker, also referred to as a wager system, 80. The wager system 80 may be incorporated into the race tracker system 64 and/or be provided separate therefrom. The wager system 80 may also receive race information, such as from the race tracker system 64. For example, the wager system 80 may receive data regarding the race results such relevant statistics, including position of respective birds finishing the race at the finish 14 relative to other birds, speed of any of the racing pigeons, and the like.

The wager system 80 may also be accessed by selected users, such as any of the users accessing the race tracker system 64, such as the user 76 or any other appropriate user. Further other or additional unique users may also access the wager system 80, such as unique user 84, unique user 88, and/or any appropriate user, such as user 92. The wager system users 84-92 and/or 76 may provide or make wagers (also referred to as bets) regarding any of the pigeons that participate in the race from the race start 10 to the finish 14.

Accordingly, users may wager on the race of the pigeons from the race start 10 to the finish 14 with the wager system 80 at any appropriate time based upon rules and/or system requirements of the wager system 80. Further, the unique users may only access the wager system 80 to place appropriate wagers and/or may access the race tracker 64 and the wager system 80. Nevertheless, the users may be provided results of the race and results of the wagers placed by the selected users.

The discussion above relates to an illustration including the two pigeons 20, 24. It is understood, however, that any appropriate number of pigeons may be provided from the solo pigeon loft/location for the race from the race start 10 to the finish 14. Moreover any selected number of tracking system 40 may be positioned between the start 10 and the finish 14. Each tracking system 40 may be used to track the position of the pigeons during the selected race, such as along the route 50. It is further understood, however, that any pigeon may proceed from the race start 10 to the finish 14 in a route selected by the individual pigeon that is not influenced by any owner or user influences. Thus, the solo pigeon loft/location may include a single owner that owns and controls all of the pigeons that move along the race from the race start 10 to the finish 14 during a selected race that may be referred to as a solo pigeon loft race. The solo pigeon loft race allows a solo pigeon loft owner to provide a race for tracking and/or wagering to any appropriate number of users, as discussed further herein.

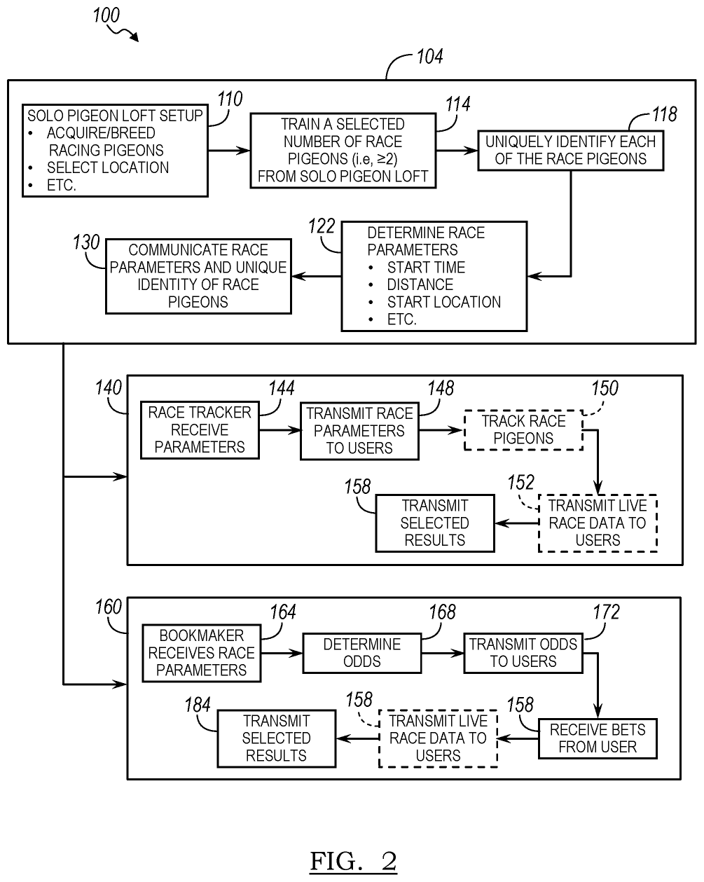

With continuing reference to FIG. 1, and additional reference to FIG. 2, a method or process 100 of preparing for and instigating a solo pigeon loft race is illustrated. The method 100 may include various sub-portions or routines, as discussed further herein. For example, the method 100 may include a loft owner or trainer portion 104, race tracker portion 140, and/or bookmaker portion 160.

The loft trainer portion 104 may include a solo pigeon loft setup in block 110. The solo pigeon loft setup 110 may include acquiring or breeding racing pigeons. The racing pigeons may include two or more pigeons that may be selected to race at a selected time, such as in a selected race. The acquisition or breeding of the racing pigeons may include husbandry of existing racing pigeons, acquisition of new racing pigeons or young pigeons (i.e., squabs). The pigeon loft owner may also select a location for the pigeon loft which may also be in any site for a race. Accordingly, the solo pigeon loft setup 110 may include a selection or acquisition of a physical site for positioning the racing pigeons that are acquired at a solo pigeon loft owner. Other actions for the solo pigeon loft setup 100 may include providing for a housing or finishing portion, selected transceivers to receive information regarding the position of the pigeons when entering or passing the finish line (e.g., entering a selected cage), or other appropriate loft setup. Accordingly, the solo pigeon loft setup 110 may include various portions and procedures to be performed to ensure that a select number of racing pigeons are provided at a solo pigeon loft and may also be a finished location.

The solo pigeon loft owner may also train a selected number of racing pigeons from the solo pigeon loft in block 114. In training the selected racing pigeons, the solo pigeon loft owner may move the pigeons to various distances and positions from the solo pigeon loft location and train them at selected training periods. The training periods may include providing or allowing the racing pigeons to fly from the selected training position back to the solo pigeon loft location to help the training of the homing and pathfinding or determination of the selected racing pigeons and/or to provide selected training statistics. Nevertheless, the solo pigeon loft owner may train a selected number of the race pigeons as race pigeons with various training techniques, such as those generally understood in the art.

The solo pigeon loft owner may also uniquely identify each of the race pigeons in block 118. Uniquely identifying each of the race pigeons may include associating the unique identifiers 28, 32 with selected race pigeons. The unique identified may include various identification members, such as leg bands, neck bands, or other appropriate markings or race pigeon attachments. The unique identifiers may further include various transceiver portions, such as GPS tracking devices, transmitters, receivers, and the like. The transceiver portions may be included in the selected attachments and/or implanted into the racing pigeon. Accordingly, each of the racing pigeons may be uniquely identified by one or more of the unique identifiers that may include one or more transceiver portions.

The solo pigeon loft owner may then determine selected race parameters in block 122. The race parameters 122 may include various parameters such as a start location, a start time, which of the race pigeons will participate in a selected race, and other appropriate parameters. As noted above, a race may include a start location and a finish location where the finish location may be location of the solo pigeon loft. The start location may be selected by the loft owner or trainer at a selected time to allow for a selected race, including length, start location, terrain, and the like. A date and time may also be selected for the race which may be based on various factors such as weather, day light time, and the like. Nevertheless, the race parameters may be determined by the loft owner for a selected race.

The race parameters may then be communicated alone and/or in addition to the unique identity of the race pigeons to participate in a selected race in block 130. The communication of the race parameters and the unique identify of the race pigeons 130. The communication of the race parameters may include the start location and/or the start time. In various embodiments, however, the race parameters may include only the selected start time and/or the selected distance which may be a straight line distance from the start location to the finish location. In various embodiments, while providing only a selected start time and a distance, the start location may be kept as a secret or confidential information to minimize or eliminate possible undesirable interactions with the racing pigeons during the race. For example, an unscrupulous individual may learn of the start location and attempt to capture and/or eliminate a selected number of the race pigeons. Nevertheless, the race parameters can include the pigeon identities based on the unique identifiers. Again, the unique identifiers may allow for communication of information regarding the unique identity of race pigeons that have started the race and the specific start time of each of the uniquely identified pigeons.

The race parameters may be communicated to a race tracking or race tracker that receives the parameters and the sub-portion 140 in block 144. Receiving the race parameters may include the receiving of a start time, receiving of a unique identity of the race pigeons participating in a race, and other selected parameters. In various embodiments, the start location may also be transferred to the race tracker for determining or allowing for the tracking of the race pigeon on a selected race day or time. The race tracker may be incorporated with the loft owner and/or may be a separate entity that tracks the race pigeons on the race day. For example, the race tracker may track the starting of each of the race pigeons such as with the start transceiver 36, tracking their location along a selected rout or tracking their location based upon a route acquired or determined by the individual race pigeons, such as with a tracker transceiver 40, and a finish time such as with the finish transceiver 44. Therefore, the race tracker may track the specific race pigeon for a selected race. This may allow for a determination of a time of travel from the race start 10 to the race finish 14, location of the selected pigeons at any given time, identity of the specific pigeons and their related time, and other appropriate statistics.

The race parameters may also be transmitted to users in block 148. Users may, therefore, be able to identify these specific race pigeons and a given start time. Users may then use the information for various purposes, such as those discussed further herein. Further a race tracker may, optionally, transmit live race data to users in block 152. As discussed above, the live race data may include an elapsed time, position of selected race pigeon (if determined or known), and a finish time and/or duration of travel time for a specific race pigeon. The transmission of live race data to users is optional in block 152 and may be provided for various users, such as at a selected cost or subscription, and/or may be emitted for selected races.

The transmission of selected results may be made in block 158. The selected results may include an elapsed travel time for a selected specific pigeons. Therefore, a race time of the specific race pigeons may be transmitted and determined for various purposes, such as discussed further herein. The users may thus know or learn the specific results of the race based upon the race track that received the initial parameters and may actually track the race pigeon in block 150.

Race parameters may also be and/or alternatively be communicated and received by a bookmaker in a sub-portion 160 such as in block 164. The receiving by the race parameter by a bookmaker in block 164 may allow a bookmaker to determine odds in block 168. The determination of odds may be any appropriate odds for the selected race pigeons and/or the various other race parameters such as a start time, start distance or race distance or other selected race parameters. The determined odds may be based upon the specific identity or unique identity of the individual birds selected to be in the race, the distance, the start time, or any other appropriate odds making parameter.

The determined odds may then be transmitted in block 172. The transmission of the odd to users may include displaying the determined odds, mailing (e.g., electronic mail, postal mail, courier, etc.) to users, or any appropriate manner to allow access to the selected odds. The bookmaker may then receive bets from users in block 176. Bets may then be received by users in any appropriate manner, such as in person bet making, electronic bet making (e.g. via an internet portal), or other appropriate manners to receive bets from users in block 176. The bookmaker may also transmit the live race data, optionally, in block 180. The bookmaker may select not to transmit live race data and the users making bets on the sub-portion 160 may receive the live race data from the race tracker in block 152 and/or only receive transmitted selected results in block 184. The selected transmitted results may include a winner, second place, or any appropriate number of places of the birds in the race, elapsed time of the race, or any other appropriate results from which odds may be determined and/or bets may have been received from the users.

Accordingly, in the method 100 the solo pigeon loft owner may set up a solo pigeon loft in a selected race parameter that may then allow for uniquely identified race pigeons to be tracked at least for a starting and ending time of a race between a starting and ending locations and/or to allow for bookmakers to provide odds and receive bets from selected users. The solo pigeon loft setup allows for all of the race pigeons from provided in the race to be kept maintained at the solo pigeon loft but allows for race between the pigeons from the solo pigeon loft so that users may track or determine the results of the race of the pigeons from the solo pigeon loft and/or place bets on one or more pigeons from the race from the pigeons from the solo pigeon loft and/or by a bookmaker to make odds and receive bets based upon the pigeons in the race from the solo pigeon loft.

As discussed above, the solo pigeon loft may be operated by a single user or entity. Each of the racing pigeons at the solo pigeon loft are maintained and kept at the solo pigeon loft. The solo pigeon loft may also be used as the finish location 14 for a race. Each of the racing pigeons from the solo pigeon loft are trained and conditioned at the solo pigeon loft and do not require the intervention or use of racing pigeons from additional and/or alternative pigeon lofts. Therefore, the solo pigeon loft may allow for efficiency of operating and communicating a pigeon race for various purposes.

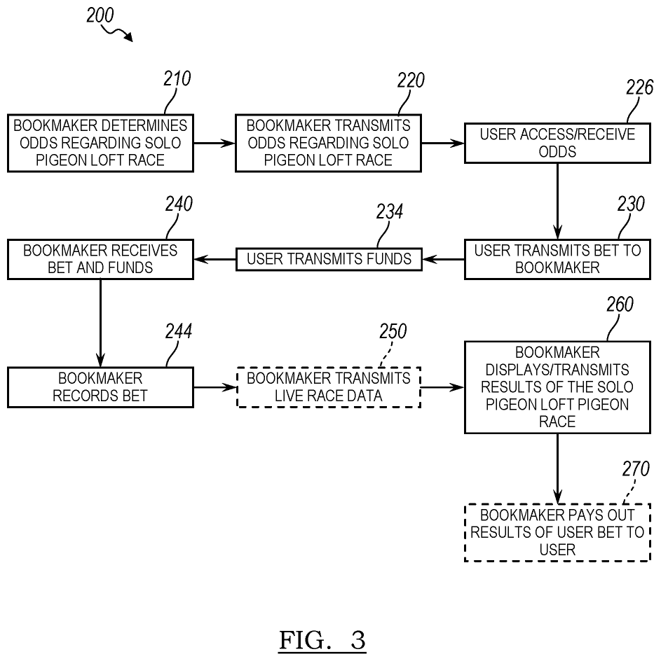

Further, as discussed above, a method 100 may be used to allow for creation of a pigeon race and/or interacting with a pigeon race. As noted above the subroutine or process 160 may include allowing a bookmaker to provide odds and allow users to bet on the pigeon race. In various embodiments, for example, a method 200 may be used to augment and/or replace the method portion 160 as discussed above. Accordingly with reference to FIG. 3, the method 200 may allow for a bookmaker to interact with various users regarding a pigeon race.

The method 200 may begin with a bookmaker determining odds regarding a solo pigeon loft race. The bookmaker may determine odds based upon various factors such as the individual racing pigeons participating in the selected race, past performance of the selected racing pigeons, distance of the race, date of the race, or other parameters or features. The different race parameters may include those noted above and may be used to determine odds for a selected race. The race parameters and the identity of the selected racing pigeons may, therefore, be used to identify odds and may include determining odds for each racing pigeon in a selected race.

The bookmaker may then transmit the odds regarding the solo pigeon race in block 220. The transmission of the odds may include transmitting individual odds for each of the racing pigeons, odds regarding two or more of the racing pigeons, or other appropriate odds for a selected race. The selected race may include a distance and/or start date and time and these parameters may also be transmitted. The bookmaker may transmit the odds in any appropriate manner such as broadcasting them with selected television broadcasts, using an internet portal, direct messaging or mailing to selected users, or any appropriate transmission method. Nevertheless, the bookmaker may transmit the odds to any selected number of users.

Users may then access and/or receive the transmitted odds in block 226. The user may access the odds, such as accessing an internet portal or other appropriate access site. Further, the user may receive the odds directly from the bookmaker such as with a mailing, an electronic mailing, or any appropriate transmission processes as noted above.

A user may then transmit a bet to the bookmaker in block 230. The user may transmit the bet to the bookmaker in block 230 also in any appropriate manner. For example, the user may use a computer terminal to with a secure login to access a bookmaker portal, such as an internet portal, to enter selected information to make a bet. The user may also transmit a bet to the bookmaker such as with a telephone transmission, electronic mail transmission, physical mail or package transmission or delivery, or other appropriate communication method. Nevertheless, the user may transmit a bet to the bookmaker for a selected race regarding the solo pigeon loft rage.

The user may also transmit funds to the bookmaker in block 234. Again the user may transmit funds through electronic transfers, such as with an electronic bank transfer, credit card transfer, or the like and/or may provide a physical transfer, such as currency, to the bookmaker. Thus, the bookmaker may receive the funds when transferred.

The bookmaker may receive the bet and/or transferred funds in block 240. The bookmaker may receive the bet and funds in block 240 for purposes of making or receiving the bet from the user and may record the bet and/or funds in block 244. Recording the bet in block 244 may include storing the bet in a selected electronic database. The database may be organized and based upon the specific user, plurality of users betting on a related or similar bet (e.g. betting on a selected bird), and/or other appropriate record systems.

The bookmaker may, optionally, transmit live race data in block 250. As discussed above the bookmaker may transmit live race data based upon tracking the racing pigeons. The race tracker 64 may track the racing pigeons and/or the bookmaker may also track the racing pigeons and transmit the live race data. Live race data may include split or interval times or distances, order of the racing pigeons at a selected period of time after the start, or other appropriate transmissions of live data. For example, an interval may also be referred to as a leg of a race and may include a set distance (e.g., between two of the tracking systems 40) for which travel times of the racing pigeons may be tracked and bets may be made regarding the same. Further, as noted above, the end race data may be used to generate odds or determine odds that are determined in block 210 on which bets may be made.

The bookmaker may display or transmit results of the solo pigeon loft pigeon race in block 260. The results may including displaying data and/or transmitted in any appropriate manner, such as transmitting the odds in block 220. The individual users may be notified regarding the results of their bets due to the results of the pigeon race. The bookmaker may, therefore, optionally in block 270 pay users based upon the results of the race and the bets made by the users. The bookmaker may not pay a user if a user does not make a bet that results in a win for the user, however, the bookmaker may generally pay the user when a winning bet is determined. Moreover, the user may then receive the payout from the bet in an appropriate manner, such as an electronic funds transfer, receiving of a physical currency, receiving a prize, or other appropriate payout.

Accordingly, method 200 may allow the solo loft owner to operate a race and a bookmaker may provide for odds on which a user may place a bet that may be managed by the bookmaker separate from and/or in concert with the solo loft owner. Therefore, the solo pigeon loft may be operated to generate a plurality of racing pigeons for a race and/or to provide for a solo pigeon loft pigeon race.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium (e.g. memory module) and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors (e.g. processor module), such as one or more digital signal processors (DSPs), general purpose microprocessors, graphic processing units (GPUs), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of bookmaking for a pigeon race, comprising:
receiving a plurality of unique identities of a plurality racing pigeons, wherein each racing pigeon of the plurality racing pigeons have one unique identity of the plurality of unique identities;
determining odds for each racing pigeon of the plurality racing pigeons for a selected race;
providing access to a user to make a bet based on the determined odds; and
conveying results of the selected race to the user;
wherein the plurality racing pigeons are all at a solo pigeon loft.

2. The method of claim 1, wherein determining odds for each racing pigeon of the plurality racing pigeons for the selected race includes evaluating a past race performance of at least one racing pigeon of the plurality racing pigeons for the selected race.

3. The method of claim 1, wherein conveying results of the selected race to the user includes providing to the user a notification via an internet portal, a direct communication at a unique address to the user, or combinations thereof.

4. The method of claim 1, providing access to the user to make the bet based on the determined odds includes:
broadcasting the determined odds for accessing by the user;
receiving a specific bet from the user for the selected race; and
recording the specific bet from the user for the selected race.

5. The method of claim 1, further comprising:
receiving bets from users regarding at least one racing pigeon of the plurality racing pigeons based on the received plurality of unique identities.

6. The method of claim 1, further comprising:
tracking each of the racing pigeons during the pigeon race of the plurality racing pigeons to determine a result of the bet.

7. The method of claim 6, further comprising:
conveying the determined results of the bet to the user.

8. A solo pigeon loft race method, comprising:
providing a plurality of racing pigeons at a selected one location in a solo pigeon loft;
providing a unique identification member associated with each racing pigeon of the plurality of racing pigeons; and
communicating to at least one user:
race parameters of a pigeon race,
unique identities of each racing pigeon based on the unique identification member associated with each racing pigeon.

9. The method of claim 8, further comprising:
training each racing pigeon to travel to the selected one location.

10. The method of claim 9, wherein an owner of the solo pigeon loft provides for the training each racing pigeon to travel to the selected one location.

11. The method of claim 8, wherein the communicated race parameters include at least one of a race start date, a race start time, a race distance, or combinations thereof.

12. The method of claim 8, wherein providing the unique identification member includes providing a transceiver operable to transmit a signal to identify the racing pigeon associated with the unique identification member.

13. The method of claim 12, further comprising:
determining race results based on the transmitted signal to a receiver.

14. The method of claim 13, further comprising:
transmitting the determined race results.

15. A system for a solo pigeon loft race, comprising:
a unique identification member associated with each racing pigeon of a plurality of racing pigeons; and
a communication system configured to communicate to at least one user:
a race parameter of a pigeon race,
unique identities of each racing pigeon based on the unique identification member associated with each racing pigeon;
wherein the plurality of racing pigeons are (i) trained to travel to a selected one location and (ii) from a solo pigeon loft.

16. The system of claim 15, wherein an owner of the solo pigeon loft provides for training each racing pigeon of the plurality of racing pigeons to travel to the selected one location.

17. The system of claim 15, wherein the communicated race parameter includes at least one of a race start date, a race start time, a race distance, or combinations thereof.

18. The system of claim 15, wherein the unique identification member is operable to transmit a signal to identify the racing pigeon associated with the unique identification member.

19. The system of claim 18, further comprising:
a result determining processor configured to receive data from a tracking system to determine race results based on the transmitted signal.

20. The system of claim 19, further comprising:
a transmitting system configured to transmit the determined race results to the at least one user.
